(19) United States
(12) Patent Application Publication
(10) Pub. No.: US 2012/0023158 A1
(43) Pub. Date: Jan. 26, 2012

(54) METHOD FOR SECURE TRANSFER OF MULTIPLE SMALL MESSAGES

(76) Inventors: Ashwin Kashyap, Plainsboro, NJ (US); Jonas Schmid, Yverdon-les-Bains (CH); Nicolas F.E. Prigent, Rennes (FR); Dekai Li, Yardley, PA (US); Saurabh Mathur, Monmouth Junction, NJ (US)

(21) Appl. No.: 13/138,758

(22) PCT Filed: Apr. 14, 2009
(86) PCT No.: PCT/US09/02330

§ 371 Date: Sep. 23, 2011

(51) Int. Cl. G06F 15/16

(52) U.S. Cl. 709/203

(57) ABSTRACT

A method and system for securely transferring a multiplicity of short messages using an unsecure connection begins by loading a secure domain component on a client device using a secure connection and then loading an unsecure domain component on the client device. Encrypted messages are sent from an unsecure server to the unsecure domain component. The client device transfers the received encrypted message from the unsecure domain to the secure domain, where the secure domain component decrypts the received encrypted messages. This method works repeatedly without reloading either the secure domain component or the unsecure domain component and by using the unsecure connection to transfer the encrypted messages.

### FIELD

The present invention relates to computer communications, and in particular, to secure communications between a client device and a server computer.

### BACKGROUND

Internet security is essential to web commerce. Secure connections allow the transfer of financial and personal records as well as other confidential information. One dominant form of communication on the Internet/web is hyper-text transfer protocol (HTTP). HTTP is an unsecure protocol to transfer data from server computer to a client device. HTTP is an example of an unsecure connection on a network between a client and a server. Other unsecure protocols include the file transfer protocol (FTP). HTTP is susceptible to “man-in-the-middle” attacks in which the attacker places itself between the communicating entities. The man in the middle impersonates each of them in front of the other. In order to make HTTP secure, a different protocol may be used. Secure Hyper Text Transfer Protocol (HTTPS) is a secure protocol that offers server authentication and communication encryption for web transactions. HTTPS is an example of a secure connection on a network between a client and a server. HTTPS is one solution to the “man-in-the-middle” type of attack but HTTPS has high overhead consequences. HTTPS limitations include the high processing power, a high latency to setup a secure connection due to authentication and key establishment, and a lack of caching. In HTTPS, the entire secure communication is encrypted differently for each session. Even if alternate protocols can solve these problems, none of them is backward compatible nor works with existing widely deployed web technologies.

Some implementations of HTTPS are implemented as a hardware device. The encryption functions are delegated to a hardware component which does nothing but encrypt content. However, this hardware enhancement does not solve the latency problem since HTTPS' secure channel establishment inherently requires more round trips than HTTP. Even if the available bandwidth increases, the round trip essentially remains the same due to hard physical constraints such as the speed of light and limits in the switching fabric.

Another aspect of HTTPS is the keep-alive requirement. Since a new HTTPS must re-establish a new set of keys in a handshaking protocol for each session, keep-alive is used to maintain a session. Keep-alive also requires a large bandwidth overhead because HTTPS requires many timed transactions, is a stateful protocol, and consumes a significant amount of memory. On the other hand, HTTP is a stateless protocol and is much lighter to have keep-alive connections for millions of users. For these reasons, several websites simply do not use HTTPS unless it is absolutely necessary. One example of HTTPS use is when a web customer transmits financial information in association with a web purchase.

Many web applications that use HTTPS batch data so that individual objects do not need to be retrieved when the user requests them. One good example of this is Gmail that fetches emails in batches of 20 and displays them only when the user requests them. This reduces frequent communication with the server and hence reduces latency even when HTTPS is used. The main limitation of this approach is that it cannot be applied to highly interactive applications such as web chat or RPC requests.

Another approach to solve the HTTPS latency problem is to provide an application driven encryption mechanism. The idea of application driven encryption is to install an application on the user's machine that decrypts the content received by the browser. In this approach, a password must be known to the user which has to be entered manually. Since the file is generated once and may be downloaded by the user, the password cannot be changed easily. Furthermore, due to the user interaction, the password cannot be more than 10 or 15 characters in length.

Another approach to address HTTPS limitations is to use a Flash or Java software component. Here, it is possible to transmit a Flash component with the decode routines and key via HTTPS and embed it so that it can access data via HTTP. The secure Flash component can then decode data and render it suitably. The drawback of this approach is that the Flash plug-in needs to be installed. This method is also not secure, since Flash or Java is being used without cross domain security. It is possible to inject malicious components via the unsecure path that can compromise the securely transmitted component.

Another approach to solve the problems of HTTPS is to use Asynchronous JavaScript and XML Secure Socket Layer (ASSL). ASSL is a web-application-level encryption and authentication system. It works by using a combination of JavaScript and a server-side script. It provides encryption similar to HTTPS, by creating a secure layer from the browser to the server over HTTP. It prevents the content to be sniffed, but does not prevent a “man-in-the-middle” attack since there is currently no trust system for the public keys that are used. Also, it is possible to modify the decrypt routines since it is transmitted unsecurely over HTTP. The latter problem of delivering the decrypt routines over HTTP is inherently unsecure. There are several solutions similar to this that assume that the “man-in-the-middle” attack does not occur and thus, ignores one important aspect of security.

Often, it arises that there is a large collection of documents/messages that are small in size where the client accesses them sporadically. In this situation, HTTPS may be extremely inefficient because of the long latency in setup, the difficulty in maintaining keep alive, and the need to re-establish a new HTTPS session when a session times out. HTTPS′ inefficient uses include typical scenarios for making sporadic remote procedure calls (RPCs), web email, web spreadsheets, web chat, and the like. In this situation, it is impractical to maintain a client-server keep-alive HTTPS connection because the overhead of doing this for millions of users is extremely high. Without using keep-alive, a new HTTPS connection must be established for fetching small amounts of data. In such a situation, the overhead of establishing the HTTPS connection easily outweighs the transmission time for the small message. This is because, in order to establish a HTTPS connection, several parameters must be negotiated between the client and the server and this causes multiple round-trip information exchanges. Technologies such as hardware decryption and SSL connection reuse are not useful here as the problem is not CPU bound but is due to the excessive round trip message exchanges.

### SUMMARY

The present invention is directed to methods and apparatus to address the above-mentioned limitations of exclusively using HTTPS for secure communications. The present inventive methods combine HTTP, HTTPS, and JavaScript to provide secure, low latency communication that is backward compatible with existing systems and works in any JavaScript enabled browser. This method presented is as secure as the HTTPS protocol, but has the advantage that the server side resource requirements are similar to HTTP. In addition, using the present invention results in lower server side resource consumption, enables caching of encrypted content, and provides a low latency client-server communication. Although HTTP and HTTPS are used in the descriptions herein as examples, one of skill in the art understands that the invention can be extended to other combinations of unsecure and secure protocols respectively.

One embodiment of the invention includes a method for a client device to interact with both a secure server computer and an unsecure server computer. The interaction between the secure server computer is only for receiving a first software component/application transmitted using a secure connection between the client device and the secure server computer. The first software component/application is called an HTTPS secure component (SecCom) herein and is part of a secure domain within the client device. After the HTTPS-secure component is installed in the client, then the secure server is not needed in order to securely transfer information between the client and the unsecure server. The unsecure server provides to the client a second component transmitted using an unsecure connection. The second software component/application is called a HTTP-bridge component (BriCom) herein and is part of an unsecure domain within the client device. This component is used by the client to transfer information to and from the unsecure server.

To securely transfer information from the unsecure server to the client after the first and second components are installed in the client, the client requests a content object from the unsecure server. The unsecure server responds to the request and the client receives the encrypted content object from the unsecure server. The requested content object is received by the second component in the unsecure domain. The client device transfers the encrypted content object from the unsecure domain to the secure domain. Once in the secure domain of the first component, the encrypted object can be decrypted using the first component. The resulting decrypted content object can then be rendered for the client.

Additional features and advantages of the invention will be made apparent from the following detailed description of illustrative embodiments which proceeds with reference to the accompanying figures.

### BRIEF DESCRIPTION OF THE DRAWINGS

FIG. 1 illustrates an example system in which aspects of the invention may be practiced;

FIG. 2 illustrates an example client device hardware block diagram in accordance with aspects of the invention;

FIG. 3 illustrates components in a client device related to aspects of the invention;

FIG. 4 illustrates a basic transaction diagram in accordance with aspects of the invention;

FIG. 5 illustrates a client request for a secure transfer of information according to the invention;

FIG. 6 illustrates an example method performed by the client device according to aspects of the invention; and

FIG. 7 illustrates an example method performed by the unsecure server according to aspects of the invention.

### DETAILED DISCUSSION OF THE EMBODIMENTS

As used herein, “/” denotes alternative names for the same or similar components or structures. That is, a “/” can be taken as meaning “or” as used herein. The present invention is a secure method to transfer information that provides a resistance to “man-in-the-middle” attacks, reduces communication round trips when compared to pure HTTPS use, reduces server overhead in terms of CPU and memory, is compatible with any current web browser with JavaScript enabled, and offers encrypted document caching at proxies, content delivery networks (CDNs), and the like.

In an aspect of the invention, sensitive web documents such as emails, spreadsheets or chat messages are encrypted using a symmetric key. These encrypted binary large objects (blobs) might be stored or just transit through the unsecure server. An HTTP blob is any opaque data that can be retrieved via HTTP from the unsecure server. In this context, a blob is some document or message that is sensitive and is encrypted. The unsecure server relays the blobs to a suitably authenticated client via HTTP. The blob is then decrypted by an HTTPS-secure component/application. The decrypted blob is then suitably rendered for human interaction. The component/application may be a script, computer code, software application, applet, or any other set of computer instructions that, when executed, performs a function in a in a network-based client and server system.

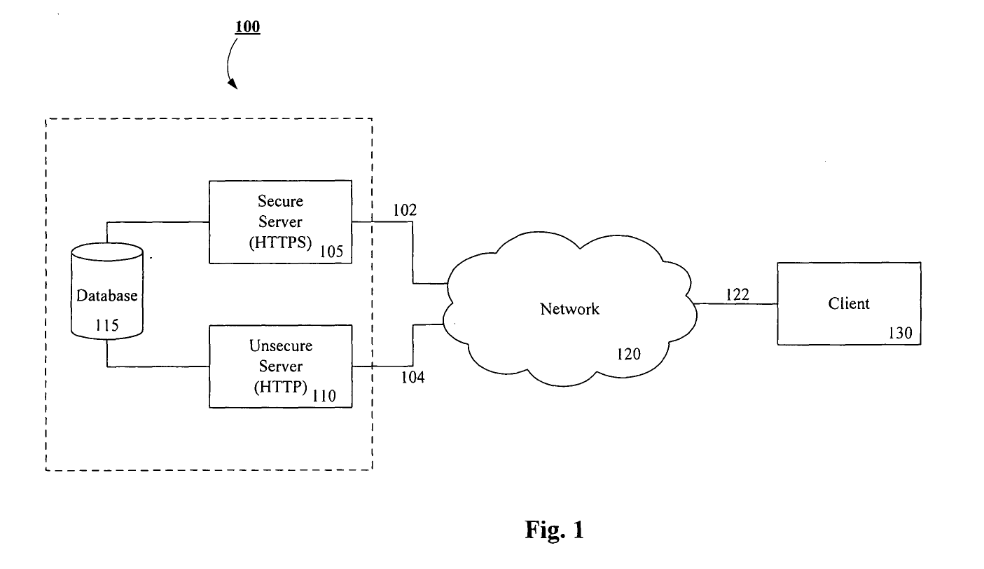

FIG. 1 depicts a typical configuration 100 for using HTTPS as a secure data transfer mechanism. FIG. 1 also represents an environment in which the current invention may be practiced. In FIG. 1, a client device 130 can access an unsecure server computer 110, such as an HTTP server, via a network 120, such as the Internet or some other local area network (LAN) or wide area network (WAN). The client 130 may access the unsecure server 110 and wish to transfer (upload or download) information securely. To accomplish this, the secure server 105, such as a HTTPS server, establishes a secure relation for the secure session. Information/data/content is then transferred between the client and secure server 105. Database 115 serves both the secure server 105 and the unsecure server 110 to share information concerning the data to be transferred, authentication information, and the like. Often, the secure server 105 and the unsecure server 110 are operated by the same entity to accommodate the sharing of information via database 115. Thus, although referred to as separately functioning entities, the secure 105 and unsecure server 110 may be the same server providing different operating modes (i.e. a secure channel and an unsecure channel).

The secure connection established between the client and the secure server 105 may be subject to HTTPS limitations such as high overhead and latency as well as secure keep-alive overhead. As noted above, these limitations can be so severe in terms of performance and resources that secure communications should avoided until absolutely necessary. However, a reduction in overhead, latency, and secure keep-alive can be obtained by using aspects of the present invention via a modification of the client.

It is noted that, the present invention is not intended as a global replacement for HTTPS. For some situations, it might be better and faster to simply encrypt everything with HTTPS. However, when there is a large collection of documents that are small in size and that the client accesses sporadically or to make sporadic remote procedure calls (RPCs), the present invention is more time and resource efficient. The present invention can be most effectively used in applications such as web email, web spreadsheets, web chat, and the like. Globally, these may be termed small messages. In these applications, it is impractical to maintain a client-server keep-alive HTTPS connection because the overhead of doing this for millions of users is extremely high. Without using keep-alive, a new HTTPS connection must be established for fetching small amounts of data. This presents a huge overhead and resource requirement. In such a situation, the overhead of establishing the HTTPS connection easily outweighs the transmission time for the small message. This is because, in order to establish a HTTPS connection, several parameters must be negotiated between the client and the server and this causes multiple round-trip information exchanges. Technologies such as hardware decryption and secure socket layer (SSL) connection reuse are not useful here as the problem is not CPU bound but is due to the excessive round trip message exchanges. The present invention addresses this concern.

In the present invention, both the HTTP-bridge component/application and the HTTPS-secure component/application are located in the browser of the client device. Encrypted objects/content/program and or data/information are fetched via HTTP protocol and not the secure HTTPS protocol. In the present invention, the bridge and secure components that are loaded into the client device are much lighter from a resource consumption perspective as compared with HTTPS. Using the current invention, the maintenance of a HTTP keep-alive connection, as needed, is less of a burden as compared to HTTPS keep-alive because, by comparison, HTTP is a stateless protocol.

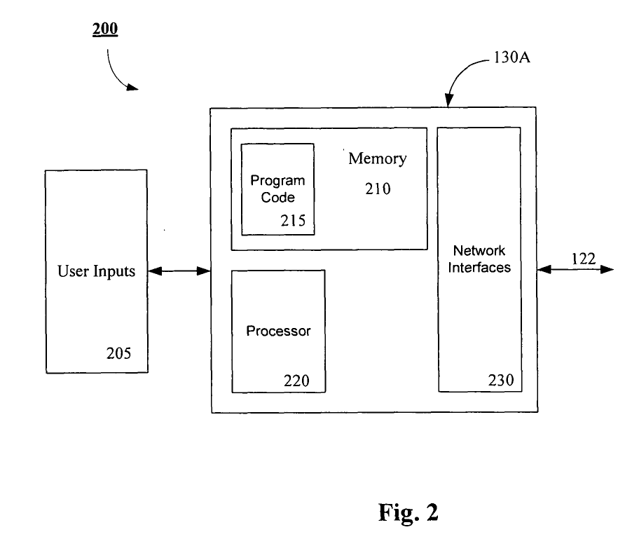

An example configuration 200 of a client device in which the present invention may be practiced is shown in FIG. 2. Here, client 130A includes memory 210 to store both data and program code 215. Memory 210 may include solid state, magnetic, or optical memory types. For example, memory 210 may find form in one or more separate or combined integrated circuits, a software storage device (computer-readable media) such as, for example, a hard disk, a compact diskette, a random access memory (“RAM”), a read-only memory (“ROM”) or any other magnetic, optical, solid state media, or any combination of these. Memory 210 is capable of being segregated into at least two domains. A processor 220 is included in client 130A to provide a computing resource. Processor 220 provides fixed or programmable co-ordination of the functions and interfaces shown in the figures. Those of skill in the art will recognize that processor 220 may be any type of processor unit including a central processing unit, multiple processors, application specific integrated circuits, or logic control circuits and the like.

Network interface 230 includes hardware and software elements to enable communication with networks such as a local area network (LAN), a Wide Area Network (WAN), a Wireless Local Area Network (WLAN), or other types of networks. The client 130A is shown in FIG. 2 as connected to network 120 of FIG. 1. User inputs block 205 include input and output devices such as a monitor or display, keyboard, mouse, light pen, stylus, or any other type of user interface known in the art. Also used, but not shown are analog drive circuits for the interfaces, power supplies, and other electronics may be used in combination to realize the functionality of the devices of FIG. 2 and the other figures presented herein.

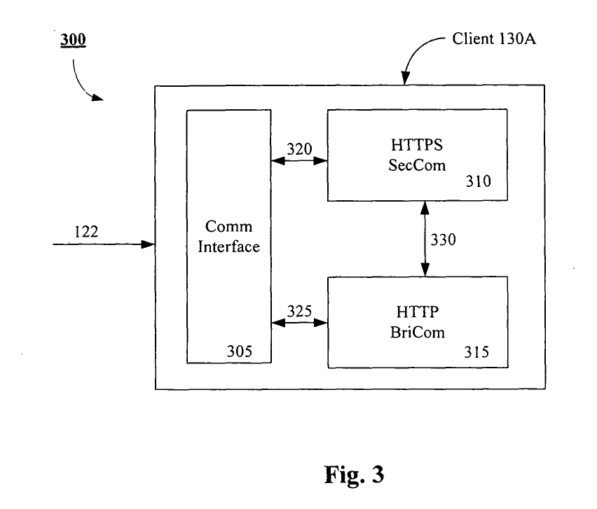

To accommodate the present invention, the elements of configuration 300 shown in FIG. 3 are included in client 130A. FIG. 3 includes an interface to network 120 via a communication interface 305. Also included are a HTTPS-secure component/application (SecCom) 310 which may be implemented as a software component that is securely delivered via a secure connection, such as an HTTPS connection. The HTTPS-secure component contains a shared secret, the decode routines, and a technique/routine/program to communicate with the HTTP-bridge component/application (BriCom) 315. In one aspect of the invention, obtaining the HTTPS-secure component is only accomplished via a secure means. The HTTPS-secure component is in communication with the communication interface via link 320. The secure component optionally renders the data to the user via display, audio or other means. Rendering an object may be defined as any method to express the object to a client/user, such as, but not limited to, an audio or video expression using such means as audio transducer devices/speakers, video display/monitor devices, or via any other method that is perceivable by a client/user. For example, a rendered object may be a file or other object that is directly rendered via audio, visual, or other means for client/user perception. Alternatively, a rendered object may be a file or other object that is used to modify or transform audio or video content that is subsequently rendered via audio, video, or other means for the client/user. The rendering may be in real-time or the object or its resultant effect may be stored such that the expression of the object or modified content is presented to the client/user at some later time.

The HTTP-bridge component/application (BriCom) 315 of FIG. 3 is a software component delivered via HTTP that contains a technique/routine/program needed to request other software objects/content on the unsecure server 110, such as HTTP server content and other objects/content. Examples of content objects include, but are not limited to text, characters, symbols, images, and files of any type. The HTTP-bridge component 315 also includes a technique/routine/program to communicate with the HTTPS-secure component. The HTTP-bridge component is in communication with the communications interface 305 via link 325.

As used in the present invention, the term domain refers to a group of computers and devices, including pathways within devices, on a network that are administered as a unit with common rules and access procedures. The term domain may be used in the context of HTML page using JavaScript. A domain identifies a computer or site on the interne, including the protocol and port that is used to communicate with the site. For example: a typical address of the form http://www.name.com is a domain that identifies the site www.name.com which uses the HTTP protocol to communicate. This domain is different from https//:www.name.com because the HTTPS protocol that is used to communicate is a secure protocol that is different from the unsecure HTTP protocol. Generally, a secure domain uses the HTTPS protocol to communicate and an unsecure domain uses the HTTP protocol to communicate. In the context of an HTML page using JavaScript, a first component/application can access and manipulate a second object (this includes components/applications, text, images etc.) that originates from the same domain. The component/application may also initiate a communication request only to the originating domain. All other forms of cross-domain interaction and communication are disallowed by the browser as they are insecure. One exception to this rule is the ability to exchange messages between cross-domain components/applications as depicted in link 330. An HTML page can simply include, without manipulation or interaction, several objects or simply reference objects from multiple domains having different sites or protocols, but no real manipulation of one object by another is generally possible if they originate from different domains. The HTML page itself is served from a certain domain. In the context of the present invention, a component/application originating from the unsecure domain cannot access or manipulate objects originating from the secure domain and vice-versa. Also, in the context of the present invention, no form of cross-domain transfer is possible without using the cross domain transfer link 330. Without cross domain message passing, the unsecure component/application can only complete a communication request to the unsecure domain. The same is true for the secure component. The present invention operates in the context of a web browser with JavaScript enabled to allow one component/application to interact with another component/application using cross domain communication via message passing.

Cross domain link 330 may be implemented as cross domain message communications. In one aspect of the present invention, the HTTPS-secure component can retrieve encrypted messages via HTTP and decrypt them. This cannot be done directly due to security restrictions placed on JavaScript that prevent cross domain information exchange. Normally, Document Object Model (DOM) Application Programming Interfaces (APIs) can be used to access and manipulate elements on an HTML page. But, because of the prohibitions in cross domain transfers between secure and unsecure domains, none of the DOM APIs can be used to access components from another domain to transfer messages. This is applicable even if the HTTP and HTTPS server are one and the same, with the same fully qualified domain name (FQDN), because the protocol and ports are in different domains. The present invention can use several ways to overcome this problem without using Flash or Java or a custom plug-in.

Some solutions to the cross domain problem exist. One is by using the window.location.hash. The window.location.hash DOM object can be used by the present invention to exchange information between the HTTPS-secure component and the HTTP-bridge component securely. This DOM object technique works in almost all existing browsers and is secure as the messages are validated before being processed.

Another solution to the cross-domain problem is the use of a Cookie. With the use of a cookie in the present invention, the HTTP-bridge component first fetches the blob and then sets a cookie whose content is the blob using standard JavaScript techniques. The HTTPS-secure component then reads the cookie and processes it appropriately. This technique is secure because the secure component (SecCom) validates the cookie before processing it further. The process might have to be repeated due to size limitations placed on cookies.

Another solution to the cross-domain problem is the use of a window.postMessage. It is possible to use the window.postMessage and document.addEventListener functions to accomplish communication securely. These communication techniques have been added to the upcoming HTML 5 standard and are already available in some browsers. They also allow authentication of messages by verifying the originating domain. Since this communication technique is implemented natively in the browser, it is fast and provides a clean mechanism to accomplish the cross domain communication.

In one implementation of the present invention, the window.postMessage cross domain communication techniques is used to accommodate cross-domain data transfers. It is nevertheless possible to implement a combination of the above three communication technique to ensure backward compatibility with older browsers as well as to take advantage of newer browser features. So, the actual communication technique or mechanism used for cross domain message transfers can be determined by probing for the browser's feature set or by detecting the browser version.

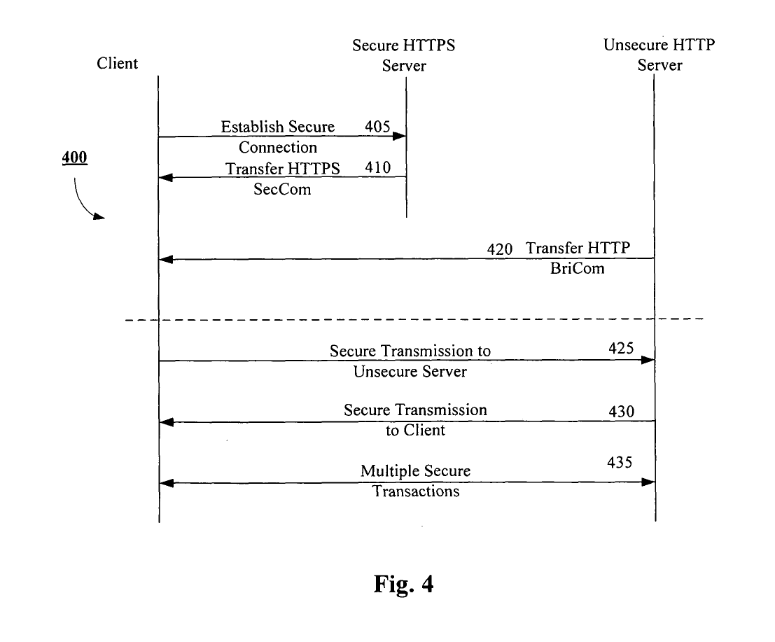

FIG. 4 depicts a transaction diagram 400 to transfer a collection of documents that are small in size. Examples of such transfers may be sporadic in nature and include remote procedure calls (RPCs), web email, web spreadsheets, web chat, and the like. The transaction diagram of FIG. 4 includes three entities; a client, a secure server, and an unsecure server. As will be understood by the description below, the secure HTTPS type server is used only to securely deliver the HTTPS-secure component (SecCom). Afterwards, other aspects of the invention are used to make the multiple secure transactions using the unsecure server. The HTTPS server is not used in the actual data transaction between the unsecure server and the client.

Initially, the client/user establishes a secure connection 405 between the client and the secure server. Once a secure connection is established, the HTTPS-secure component SecCom is transferred securely 410 to the client from the secure server. After the HTTPS-secure component is transferred to the client, then there is no need to further use the HTTPS-secure connection. Continued use is not necessary for the present invention. Thus, the high overhead and high latency HTTPS mechanism need not be used or repeated for further secure transactions according to aspects of the invention.

The transaction diagram 400 continues at message 420 where the unsecure server, using HTTP, transfers the HTTP-bridge component BriCom to the client. The client, now loaded with the HTTPS-secure component and the HTTP-bridge component, is able to provide a secure transmission to the unsecure server as represented by signal/message 425. Also, the unsecure server 430 is able to provide a secure transmission to the client as shown as signal/message 430. Combinations of signals/messages 425 and 430 can be repeated a multiplicity of times as represented by signals/messages 435. Note that according to aspects of the invention, secure transactions are performed between a client and an unsecure server. Also note that the HTTPS protocol is not needed to transfer secure messages between the client and the unsecure server.

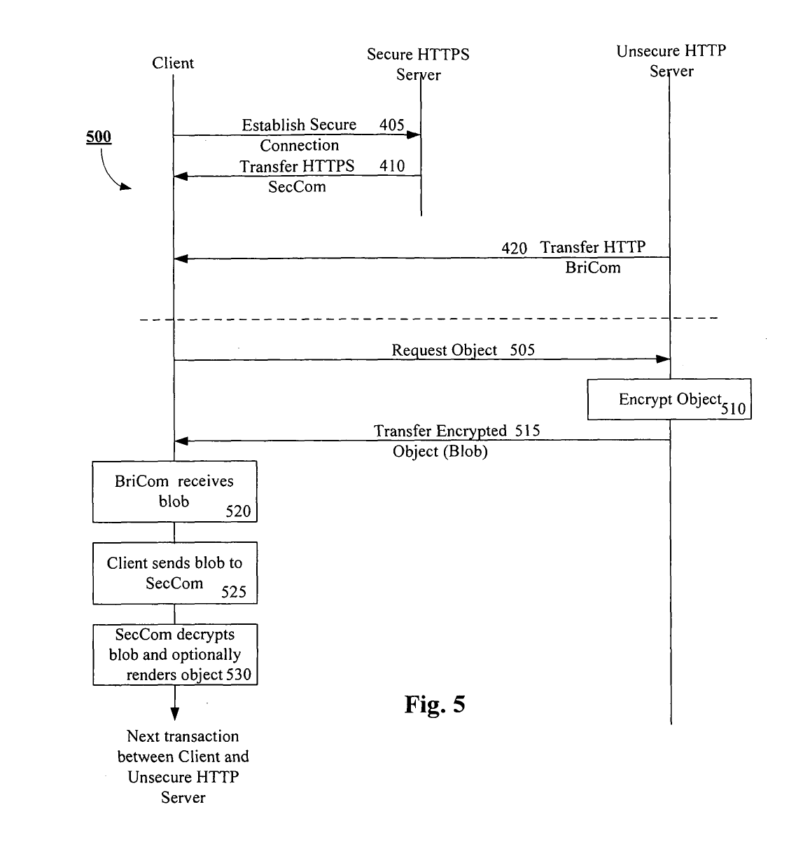

FIG. 5 is an example transaction diagram 500 that represents a client request for a secure information transfer similar to signal/message 430 shown in FIG. 4. Shown in FIG. 5 are the setup signal/messages that are used to load the HTTP-bridge component BriCom and securely transfer the HTTPS-secure component SecCom to the client. These messages, 405, 410, 420 need only be performed once for multiple secure transfers between the client and the unsecure server. Thus, the example transaction to retrieve information securely from the unsecure server begins below the dotted line in FIG. 5; that is, anytime after an initial loading of the SecCom and BriCom components into the client.

The client requests a content object 505 from the unsecure server. The content object may be any software object such as, but not limited to a file, a program, or any form of data or information. The client request can be performed in either a secure manner using HTTPS or in an unsecure manner using HTTP. In a preferred embodiment, the request is performed in an unsecure manner to advantageously avoid the HTTPS overhead. The server receives request 505 and encrypts the content object 510 in a form that the HTTPS-secure component SecCom can accommodate. The encrypted version of the requested content object, now a binary large object (blob), is then transferred from the unsecure server to the client using signal/message 515. At the client, the HTTP-bridge component BriCom receives the blob 520. Since the received blob is encrypted, the HTTP-bridge component cannot decrypt it. The blob is transferred to the HTTPS-secure component SecCom for processing. As this is a cross domain transfer, one of the three techniques for cross domain transfer is used to transfer the received blob to the HTTPS-secure component SecCom at 525.

After the retrieved blob is transferred, the HTTPS-secure component SecCom proceeds to authenticate the blob, and decrypts the requested content object 530. The HTTPS-secure component can then optionally render the content object for display, audio or other formats. The next transaction between the client and the unsecure server can then occur. In one aspect of the invention, the blobs must be transmitted at signal/message 515 via HTTP by the HTTP-bridge component of the client. But for security reasons, decryption of the blob must be performed by the HTTPS-secure component of the client. Note that the HTTP-bridge component cannot access the contents of the HTTPS-secure component due to cross domain security restrictions imposed by browsers. However, it is possible to send messages that can be validated and further processed by the HTTPS-secure component. This mechanism of the invention ensures that a hacked HTTP-bridge component cannot steal information from the secure HTTPS-secure component. It also ensures that tampered messages can be reliably detected and discarded if received message quality, authentication, or decryption activity errors or other security threats occur during an object transfer between the unsecure server and the client.

In one implementation, the HTTP-bridge component BriCom and HTTPS-secure component SecCom are constructed as iframes. All communication and decryption routines can be implemented as JavaScripts that run in the context of the iframe. These two iframes, containing the bridge component BriCom and the secure component SecCom, communicate by sending messages as described above. In one implementation, successful secure transactions between an unsecure server and a client were performed using HTTP and the RC4 algorithm.

In one aspect of the invention, it is assumed that standard secure encryption routines are available at server side and that the decrypt routines on the client side can be implemented in JavaScript securely. This also applies while validating data. There are many signature verification schemes available that are secure with an available JavaScript implementation. There are also various schemes that can be used, such as key refresh, while implementing decryption routines to enhance security and performance. It is understood that these security enhancements should be implemented securely and suitably by someone skilled in the art.

One aspect of the present invention is consideration of a separate domain for blobs. One class of attacks is to publish a malicious page which then embeds the HTTP-bridge component. When a user is tricked into visiting the page, it is possible for the malicious page to request sensitive information from the HTTP-bridge component by sending it messages. Hence, it may be desirable for the HTTP-bridge component to only retrieve encrypted blobs. This can be easily achieved by publishing the HTTP-bridge component on a separate domain that only serves blobs to authenticated users. For example, a website could be established for the purpose of sending blobs to the HTTP-bridge component and another website could be used for sending insensitive components such as images and style sheets.

Another consideration is embedded links in blobs. When a blob has links to other blobs, these links can be retrieved and processed. One way to handle this is to load all of the referenced links in the blob by a JavaScript function instead of by a direct request. This function, which is implemented in the HTTPS-secure component, first sends a message containing the URL of the blob to the HTTP-bridge component, requesting the bridge component to download the blob. Once the blob has been retrieved, the rest of the process is the same as described above with respect to FIG. 5. In one implementation, a component that mimics the well known XMLHttpRequest component, but works in a cross domain fashion is used. Callbacks can be specified to render the decrypted information.

In another aspect of the invention, caching of HTTP documents may be implemented. Most modern browsers do not store HTTPS documents on disk but only cache them in memory. Additionally, this memory is cleared when the user navigates away from the website. This behavior provides the right balance between security and performance as it would be unacceptable to reload the HTTPS-secure component whenever a new blob is loaded.

Since the blobs are being served by HTTP, the blobs might be cached on disk or even at intermediate points, such as proxy sites and servers. This caching capability does not pose a security risk as the blobs should be strongly encrypted using a key with high entropy. These keys can also be periodically refreshed to enhance security.

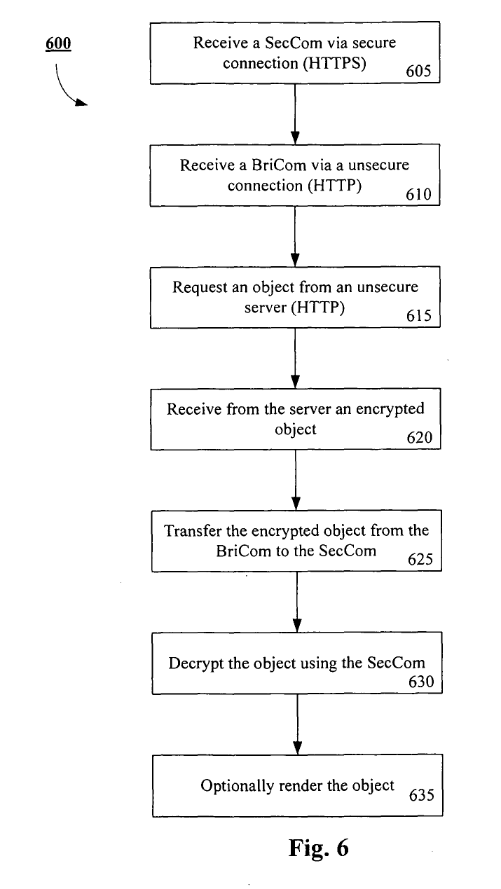

FIG. 6 represents an example method 600 exercised at the client device in accordance with the principles of the present invention. Setup for secure communications between a client and an unsecure server includes steps 605 and 610. At step 605, a HTTPS-secure component SecCom is received at a client via a secure connection, such as via a HTTPS connection. At step 610, the client receives a HTTP-bridge BriCom via an unsecure connection to an unsecure server. At step 615, the client requests a content object from the unsecure server using the HTTP-bridge component. At the unsecure server, the requested content object is retrieved and encrypted in a manner compatible with the HTTPS-secure component of the client. The encrypted content object (blob) is received at the client 620 using the HTTP-bridge component from the unsecure server. At step 625, the client transfers the blob from the bridge component BriCom to the secure component SecCom using a cross domain form of transfer. In one embodiment, one of the three types of cross domain techniques described above is used. In another embodiment, another compatible cross domain transfer technique is used. Once in the secure component SecCom, the blob is decrypted to reveal the requested content object at step 630. The secure component can then be used to render the content object at step 635. As stated above, rendering is inclusive of a step to express the content object or its effect to a client/user such that the user/client either perceives the content object itself, (via audio or visual display means), or such that the client/user perceives other content that is modified or transformed by the content object. An example of other content that is modified by a content object is where the content object is used to enhance the playback of an audio or video file or where the content object is used to place a watermark on an audio or video file. In all cases, the result is rendered to the client/user.

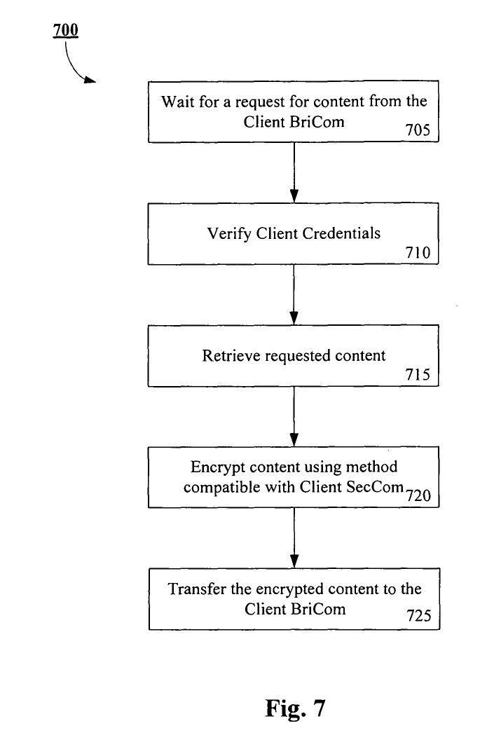

FIG. 7 represents an example method 700 exercised at the unsecure server in accordance with the principles of the invention. Not shown in FIG. 7 is the delivery from the unsecure server to the Client of a HTTP-bridge component BriCom. After the client has both the HTTPS-secure component from a secure source and the HTTP-bridge component, then the client can request a content object from the unsecure server. This request is generated by the HTTP-bridge component at the client and is received by the unsecure server at step 705. At the unsecure server, the client credentials are verified at step 710, and if acceptable, the requested content/object is retrieved at step 715. At step 720, the retrieved content is encrypted using a technique compatible with the HTTPS-secure component SecCom installed on the client device. The encrypted content object, now considered a blob, is transferred to the bridge component BriCom of the client in step 725. At this point, the unsecure server waits until another request is made from the client. If so, the method 700 repeats at step 705.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms (for example, a hardware apparatus, hardware and software apparatus, or a computer-readable media). An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data transmission and reception. Examples of equipment include video coders, video decoders, video codecs, web servers, set-top boxes, laptops, personal computers, and other communication devices. As should be clear, the equipment may be mobile or fixed in location.

Additionally, the methods may be implemented by instructions being performed by a processor, and such instructions may be stored on a processor or computer-readable media such as, for example, an integrated circuit, a software carrier or other storage device such as, for example, a hard disk, a compact diskette, a random access memory (“RAM”), a read-only memory (“ROM”) or any other magnetic, optical, or solid state media. The instructions may form an application program tangibly embodied on a computer-readable medium such as any of the media listed above. As should be clear, a processor may include, as part of the processor unit, a computer-readable media having, for example, instructions for carrying out a process. The instructions, corresponding to the method of the present invention, when executed, can transform a general purpose computer into a specific machine that performs the methods of the present invention.

1. A method performed by a client device operating on a network, the method comprising:
(a) receiving a first software component transmitted using a secure connection on the network;
(b) receiving a second software component transmitted using an unsecure connection on the network;
(c) requesting a content object using the unsecure connection;
(d) receiving, via the unsecure connection, an encrypted version of the requested content object;
(e) transferring the encrypted version of the requested content object from an unsecure domain containing the second software component to a secure domain containing the first software component;
(f) decrypting the encrypted content object using the first component to obtain the requested content object; and
(g) rendering the requested content object on the client device.

2. The method of claim 1, wherein step (a) comprises receiving the first software component comprising a shared secret, a decode routine, and a routine to communicate with the second software component.

3. The method of claim 2, wherein the first software component is transmitted securely using a secure hyper text transfer protocol.

4. The method of claim 1, wherein step (b) comprises receiving the second software component comprising a routine to request objects via the unsecure connection and a routine to communicate with the first software component.

5. The method of claim 1, wherein step (d) is performed using hyper text transfer protocol.

6. The method of claim 1, wherein step (e) comprises transferring the encrypted version of the content object using a cross domain message transfer mechanism.

7. The method of claim 6, wherein the cross domain message transfer mechanism comprises one of a windows.location.hash routine, a cookie, or a window.postMessage routine.

8. The method of claim 1, further comprising:
performing steps (c) through (f) a plurality of times for a plurality of other objects wherein steps (a) and (b) are not repeated.

9. A client device comprising:
a network interface that connects the client device to an unsecure server and a secure server;
a processor having access to memory;
a first component stored in a first domain, the first component transferred into the memory by a secure connection to the secure server;
a second component stored in a second domain, the second component transferred into the memory by an unsecure connection to the unsecure server; and
a cross domain message transfer mechanism;
wherein an encrypted object transferred by the unsecure connection into the second component is decrypted by the first component after the processor invokes the cross domain message transfer mechanism to transfer the encrypted object from the unsecure domain to the secure domain.

10. The device of claim 9, further comprising a rendering mechanism for rendering decrypted objects.

11. The device of claim 9, wherein the first component comprises a shared secret, a decode routine, and a routine to communicate with the second component.

12. The device of claim 9, wherein the second component comprises a routine to request objects via the unsecure connection and a routine to communicate with the first component.

13. The device of claim 9, wherein the first component is securely transferred into the first domain using secure hyper text transfer protocol.

14. The device of claim 13, wherein the cross domain message transfer mechanism comprises one of a windows.location.hash routine, a cookie, or a window.postMessage routine.

15. The device of claim 9, wherein a plurality of encrypted objects are transferred to the second component using an unsecure connection and decrypted by the first component.
